(19) United States
(12) Patent Application Publication
(10) Pub. No.: US 2026/0141108 A1
(43) Pub. Date: May 21, 2026

(54) SECURE DATA ERASURE FRAMEWORK USING INDIVIDUALIZED ENCRYPTION KEY MANAGEMENT

(71) Applicant: PAYPAL, INC., San Jose, CA (US)

(72) Inventors: Chetan Nadgire, Fremont, CA (US); Arunkumar Kannimar Ponnaiah, Chennai (IN); Ramalingam Sreenidurai, Pollachi (IN); Rama krishnaa Palanisamy, Erode (IN); Chetan Meda, Hyderabad (IN)

(21) Appl. No.: 18/953,807

(22) Filed: Nov. 20, 2024

(51) Int. Cl. G06F 21/62; G06F 21/60

(52) U.S. Cl. CPC G06F 21/6245; G06F 21/602; G06F 21/604

(57) ABSTRACT

There are provided systems and methods for a secure data erasure framework using individualized encryption key management. A service provider, including an electronic transaction processor, may provide data management and secure erasure through individualized encryption keys that may be managed and deleted to render encrypted data unreadable. When a device interacts with a service provider and provides or generates user data, the user data may be stored in accordance with an encryption process that encrypts the data using an encryption key for a corresponding account. Thereafter, the encryption key may be stored by a key store and not replicated elsewhere. When data is needed, the key store may be used by a trusted decryption platform and not shared. As such, when data is required to be erased or deleted, the data may be removed from availability with the service provider by implementing a secure key deletion process.

### TECHNICAL FIELD

The present application generally relates to automated data privacy protection and data erasure for consent enforcement and more particularly to utilizing individualized encryption keys to ensure data erasure across different data storage components.

### BACKGROUND

Service providers may have large computing systems and numerous services that provide automated interfaces and interactions with different end users, such as customers, clients, internal users and teams, and the like. Users may interact with various applications, websites, and/or other digital platforms via computing devices, as well as exchange messages and content via text messaging, emails, push notifications, instant messaging, and other electronic communication channels. This includes providing and/or sharing private data and/or privacy protected data, such as personally identifiable data (PII), know your customer (KYC) data, financial data, and the like that may be privacy protected and/or desirable to remain private or not be shared. However, advertisers and other big data users may want to obtain personal and/or privacy protected data for advertising and business purposes. Further, fraudsters may attempt to compromise sensitive data to access and/or utilize such data for fraudulent purposes, such as to perform fraudulent electronic transaction processing or account takeover.

As such, laws, rules, and regulations may govern consent to storing, sharing, and deleting user data including personal information and/or privacy protected data. However, management of this data across many different data storage components, databases, and systems is difficult and cumbersome, and it can be difficult to ascertain if data has been properly deleted, erased, and/or destroyed when requested. Thus, it is desirable for service providers to implement an automated system to manage data erasure, deletion, removal, and/or destruction in a faster and more efficient manner while ensuring a high likelihood or guarantee of proper data deletion for privacy data security and regulatory compliance.

### BRIEF DESCRIPTION OF THE DRAWINGS

FIG. 1 is a block diagram of a networked system suitable for implementing the processes described herein, according to an embodiment;

FIGS. 2A and 2B are exemplary system environments for establishing an encryption key for an account and encrypting data in order to provide secure data erasure through key deletion, according to embodiments;

FIG. 3 is an exemplary system environment for key deletion to ensure secure data erasure by rendering encrypted data unreadable and unable to be decrypted, according to an embodiment;

FIG. 4 is a flowchart for a secure data erasure framework using individualized encryption key management, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for a secure data erasure framework using individualized encryption key management. Systems suitable for practicing methods of the present disclosure are also provided.

When using computing platforms, applications, and websites of service providers, PII, KYC, privacy protected, and other personal, financial, or private data may be provided to the service provider by different users. For example, such private user data may be entered or uploaded during an account establishment or maintenance phase, while processing transactions or interacting with various computing services, users, or entities, and/or communicated via an email channel, a digital alert channel, a text message channel, a push notification channel, an instant message channel, or the like. To comply with data privacy protections, laws, rules, and regulations, the service provider may implement data security measures, and may further request consent and authorization to utilize the user data (e.g., for internal marketing, advertising, statistics and/or data research, etc.), as well as store and retain this data. However, this consent may be revoked, data may be requested to be deleted by users or other entities on behalf of users (e.g., data security and/or management services), and/or consent or authorization for data storage may expire. As such, service providers may be required to delete user data and ensure the data's erasure, deletion, removal, and/or destruction across their platforms to comply with consent, data retention requirements, and general system upkeep.

Thus, service providers establish data retention and deletion systems to provide strong privacy protection, which may be required to comply with laws, regulations, and company rules or objectives governing privacy protection, data retention, and the like. This may prevent data from being shared without consent, and privacy regulations, including the European Union's General Data Protection Regulation (GDPR) and the California Consumer Privacy Act (CCPA) mandate organizations to destroy users'personal data. As such, service providers may implement a data management and data removal system, where, after consent to store and/or utilize privacy protected data ends (e.g., is revoked, data is requested for deletion, an authorized storage time of the data expires, an account closing, as defined by a record retention schedule (RRS), etc.), the data is required to be deleted or otherwise destroyed. Conventionally, these organizations may have multiple storages where user data gets replicated and stored, which leads to difficulty in identifying where the data is stored and what needs to be deleted from each storage. Data may have redundancies, may be inadequately stored, or additional PII data that requires cleaning and deleting on systems may incidentally remain after data processing. Further, many large data stores and data warehouses may maintain read-only copies of data, which means data cannot be deleted or updated in these storages. Maintaining details of these storages and discovering PII information and the like therefore is a difficult problem to solve.

However, such data may be necessary when using computing platforms, applications, and websites of service providers, such that PII, KYC, privacy protected, and other personal, financial, or private data may be provided to the service provider by different users. Private user data may be entered or uploaded during an account establishment or maintenance phase, while processing transactions or interacting with various computing services, users, or entities, and/or communicated via an email channel, a digital alert channel, a text message channel, a push notification channel, an instant message channel, or the like. In this regard, a service provider, which may provide services to users including electronic transaction processing such as online transaction processors (e.g., PayPal®), may allow merchants, users, and other entities to process transactions, provide payments, provide content, and/or transfer funds between these users. The user may also interact with the service provider to establish an account and provide other information for the user. Other service providers may also or instead provide computing services, including social networking, microblogging, media sharing, messaging, business and consumer platforms, etc. In order to utilize the computing services of a service provider, an account with the service provider may be established by providing account details, such as a login, password (or other authentication credential, such as a biometric fingerprint, retinal scan, etc.), identification information to establish the account (e.g., personal information for a user, business or merchant information for an entity, or other types of identification information including a name, address, and/or other information), and the like.

The user may also be required to provide financial information, including payment card (e.g., credit/debit card) information, bank account information, gift card information, benefits/incentives, and/or financial investments, which may be used to process transactions for items. The account creation may also be used to establish account funds and/or values, such as by transferring money into the account and/or establishing a credit limit and corresponding credit value that is available to the account and/or card. The online payment provider may provide digital wallet services, which may offer financial services to send, store, and receive money, process financial instruments, and/or provide transaction histories, including tokenization of digital wallet data for transaction processing. The application or website of the service provider, such as PAYPAL® or other online payment provider, may provide payments and the other transaction processing services.

Once the account of the user is established with the service provider, the user may utilize the account via one or more computing devices, such as a personal computer, tablet computer, mobile smart phone, or the like. The user may engage in one or more online or virtual interactions, such as browsing websites and data available with websites of merchants. In this regard, the transaction processor or other online service provider may offer and provide computing services through data processing of account and transaction data for electronic transaction processing, as well as other data processing services. These interactions and activities, as well as their corresponding data collection processes and events, may cause the service provider to receive, generate, and/or store data, which may be privacy protected or otherwise regulated by rule, law, policy, or regulation. As such, users may wish to protect such data and manage storage and erasure of personal data, histories, and the like. The data accessed, stored, and/or utilized by the service provider may include privacy protected data, such as PII, financial data, health data, transaction data and/or histories, KYC data, and the like, and storage of such data may be required to be managed by the service provider using a secure data erasure framework.

According to various embodiments, such a framework may manage storage and include processes for data erasure, deletion, or other destruction using a secure and individualized key framework. The framework may utilize encryption keys to manage data destruction more efficiently and securely across data storage systems, with a higher confidence in data erasure, using the individual data encryption processes and components described herein.

For example, consents and authorizations for data store may be recorded in data records, such as a system of records (SOR), which is used to manage data security, user consent, and data erasure or deletion. PII and other sensitive data may be collected through different data collection channels including during user onboarding (e.g., PII details including first name, last name, address, and phone number), confirm you identity pages (CIP) and/or KYC pages (e.g., additional data including an identifier, such as account information, credit/debit card number (or other payment card number), or the like that may be collected to verify customer), payment channels and transaction data along with payment details, shipping addresses, etc. and/or third-party data collection for additional data required for key business functions The SOR may act as the primary data source that is trusted and authoritative for the data collected from the various channels. As such, different records of data may be managed by the SOR, and a data warehouse associated with the SOR may be used to store the data collected and/or replicated from the SOR for operational use cases. Analytics may be replicated and/or stored to read-only systems, and a deep storage may also be used and managed for low-cost data stores.

To manage data erasure and destruction from these data sources and storages, the service provider may provide a secure data erasure framework that eliminates the dependency on each domain to have processes implemented that maintain and erase data. The system does not require a large infrastructure for data discovery and deletion and may not be restricted by the immutable nature of data on some platforms. In this regard, the data erasure framework may implement encryption logic on data before sensitive, PII, personal, or other data is stored by or on one or more data platform or storage components of the service provider. Personal data, once encrypted, may only be accessed through decryption of the data at rest (e.g., data stored in a physical location, such as a hard drive or server and not being moved or transmitted) using the corresponding encryption key. Access to the cryptographic keys may be managed and governed through a centralized platform. This platform may generate new keys and associate them with an entity (e.g., user, business, merchant, organization, group of users, account, etc.), such as an account identifier (ID).

Using the keys, the data erasure framework may perform encryption before data is stored at rest and may further manage later decryption when data is accessed and/or requested. Thus, the framework may provide access management to restrict access to data only to authorized processes, systems, and users. For data erasure and destruction, the framework may provide a key deletion process that may destroy the key associated with the entity (e.g., account ID), which may correspond to an operation performed in response to a trigger or request, for example, when an RRS threshold or time to expiration of data retention is reached or in response to a user-initiated data deletion. The service may be integrated with different data lifecycle systems and processors, including user onboarding, data collection, data access, and/or data deletion/destruction to provide data encryption, management, and erasure when invoked and required.

For example, during user onboarding and/or account establishment, a new cryptographic key will be created at the time of user onboarding and associated with the account ID. Thereafter, during data collection, processes may be integrated with the corresponding computing service of the data erasure framework to perform encryption of personal data or other received data designated for encryption using the cryptographic key associated with the account before the data is stored in databases. During data access, various processes using the encrypted data may have an integration with the key and data management service, similar to data collection, so that decryption is performed using the same key. The data destruction platform may utilize an integration with the service to have the key destroyed when requested or required by RRS thresholds, regulations, and the like. As such, destroying of the key will make decryption impossible and effectively make data unreadable. In this regard, the data management service does not require knowledge of PII data and other information and mechanisms for data storage. Instead, a single job to destroy the encryption key may address destruction of data across all storages, thereby creating a faster and more efficient system for data management, data destruction, and consent/privacy enforcement.

The data erasure framework therefore introduces encryption logic at the data access layer before sensitive data, such as PII data, KYC data, and/or other data that a user, entity, organization, or system would not want or be allowed to be exposed to others without prior consent or authorization, and other data designated for encryption is stored on any data platform so that personal data can be accessed only through decryption of data at rest. This allows for deletion of a key associated with an entity to effectively destroy or erase the data by making the data unreadable. Thus, data destruction or removal may be achieved by deleting the key associated with the account ID since this key is mandatory to access the data. Thereafter, if a data access request is received for data having a destroyed or deleted key, the data may be encrypted and unable to be decrypted (e.g., is unreadable), and the data management service may instead return pseudonymized text or the like as may be defined by a data management policy. The pseudonymized text may include data with aliases and/or other information to make data sets more private, such as by replacing information for the destroyed data and/or other identifiable data with pseudonymous data that cannot be matched to a person, account, activity, or the like.

Therefore, the service provider's system may provide an automated data management and data erasure framework and system designed to identify and protect from exposure of privacy protected user data through enforcement of data erasure and destruction policies in a faster and more efficient manner. This may be done without requiring extensive data searching and identification across multiple storage platforms and systems, thereby ensuring that a single processing job to delete an encryption key may destroy data stored in disparate systems. Further, users may be further protected from having data stored against user consent be automatically deleted across all platforms when RRS threshold and/or requests are received. This allows for faster and more efficient consent enforcement for data privacy protection and erasure, while minimizing processing jobs to enforce data management and erasure. By reducing the manual effort and providing an automated system, computing resources usage may be reduced and made more efficient, while data destruction processes may ensure a higher degree of completion. As such, an improved data erasure system may be provided to provide solutions to problems with disparate data storage in multiple data formats.

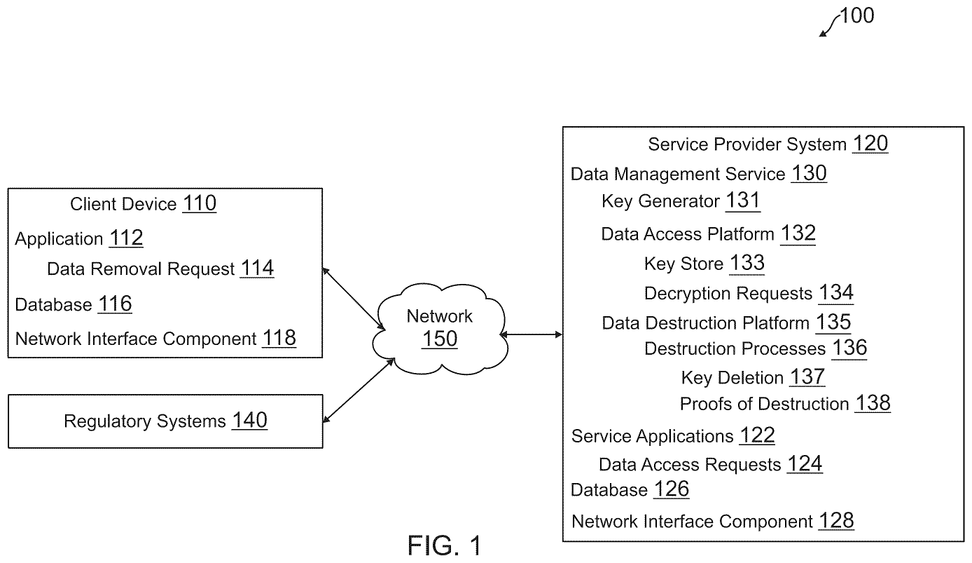

FIG. 1 is a block diagram of a networked system 100 suitable for implementing the processes described herein, according to an embodiment. As shown in FIG. 1, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100 includes a client device 110, a service provider system 120, and regulatory systems 140 in communication over a network 150. Client device 110 may be utilized by a user, customer, or the like to access a computing service or resource provided by service provider system 120, which may be provided via one or more applications, websites, and/or other digital platforms. Service provider system 120 may provide various data, operations, and other functions to via network 150. In this regard, service provider system 120 may provide a data privacy and data management framework to secure user data and enforce data erasure, deletion, and/or destruction requests are handled for proper data management. The requests to delete data may be received from client device 110 and/or based on requirements from regulatory systems 140, and proof of data destruction may be provided to client device 110 and/or regulatory systems 140.

Client device 110, service provider system 120, and regulatory systems 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Client device 110 may be implemented as a computing or communication device that may utilize appropriate hardware and software configured for wired and/or wireless communication with service provider system 120, regulatory systems 140, and/or other devices and/or servers. For example, in one embodiment, client device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly and/or be connected to provide the functionalities described herein.

Client device 110 of FIG. 1 contains an application 112, a database 116, and a network interface component 118. Application 112 may correspond to executable processes, procedures, and/or applications with associated hardware. In other embodiments, client device 110 may include additional or different modules having specialized hardware and/or software as required.

Application 112 may correspond to one or more processes to execute software modules and associated components of client device 110 to provide features, services, and other operations for a user over network 150, which may include accessing and/or interacting with service provider system 120. Interactions with service provider system 120 may occur through applications, websites, and/or other platforms that may send and/or establish data, which may be privacy protected and/or managed for data storage and erasure. In this regard, application 112 may correspond to specialized software utilized by a user of client device 110 that may be used to access a website or UI provided by service provider system 120 perform actions or operations. In various embodiments, application 112 may correspond to a general browser application configured to retrieve, present, and communicate information over the Internet (e.g., utilize resources on the World Wide Web) or a private network. For example, application 112 may provide a web browser, which may send and receive information over network 150, including retrieving website information (e.g., a website for a merchant), presenting the website information to the user, and/or communicating information to the website. However, in other embodiments, application 112 may include a dedicated application of service provider system 120 or other entity (e.g., a merchant and/or one or more of regulatory systems 140).

Application 112 may be associated with account information, user financial information, and/or transaction histories. However, in further embodiments, different services may be provided via application 112, including messaging, social networking, media posting or sharing, microblogging, data browsing and searching, online shopping, and other services available through service provider system 120. Thus, application 112 may also correspond to different service applications and the like that are associated with service provider system 120. When using application 112, user data may be provided and/or generated, such as based on different interactions by computing device 110 with service provider system 120. These interactions may include data submissions and/or collections, such as during onboarding and/or computing service usage (e.g., electronic transaction processing), but may also include interactions with service provider system 120 and/or other devices and servers.

In some embodiments, application 112 may be used to provide one or more interfaces to opt-in to data storage, sharing, and/or retention by service provider system 120, as well as change, manage, and update the consent for data retention and/or request data deletion, such as by transmitting a data removal request 114 to service provider system 120. Application 112 may provide one or more opt-in and/or opt-out requests and/or authorizations, which service provider system 120 may enforce through encryption key management and deletion. Application 112 may transmit data removal request 114 to service provider system 120 for destruction of specified data and/or an encryption key for the data, or more generally, for a user, account, or other identifier that may be used to determine one or more encryption keys for deletion that causes the data to become no longer be decryptable (un-decryptable) and therefore unreadable, as described herein. As such, client device 110 may trigger data removal request 114 externally from service provider system 120 based on a user request.

However, not all data deletion and/or destruction requests may come from client device 110, and instead internal requests generated by triggers, thresholds, and/or regulatory compliance systems and users may generate, manually or automatically by regulatory systems 140 and/or service provider system 120, requests similar to data removal request 114. Once data has been deleted, a proof of deletion, destruction, and/or erasure may be provided to client device 110, which may include proof of the encryption key deletion, a pseudonymized text for the deleted data and/or encryption of the deleted data, and the like, which may prove that the data destroyed in accordance with data removal request 114 based been rendered unreadable.

Client device 110 may further include or have access to database 116, which may correspond to different types of data storage and components including cloud computing storage nodes, remote data stores and database systems, distributed database systems over network 150, and the like used to store various applications and data. Database 116 may include, for example, identifiers such as operating system registry entries, cookies associated with application 112 and/or other applications, identifiers associated with hardware of client device 110, or other appropriate identifiers, such as identifiers used for payment/user/device authentication or identification, which may be communicated as identifying the user/client device 110 to service provider system 120.

Client device 110 includes at least one network interface component 118 adapted to communicate with service provider system 120 and/or other devices, servers, and endpoints. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider system 120 may be maintained, for example, by an online service provider, which may provide automated operations for data management, storage, and erasure through a data encryption and key management service that may delete keys to destroy stored data in accordance with data destruction requests and compliance requirements. In this regard, service provider system 120 includes one or more processing applications which may be configured to interact with client device 110, regulatory systems 140, and/or other internal and/or external computing services to provide data management and destruction as described here. In one example, service provider system 120 may be provided by PAYPAL®, Inc. of San Jose, CA, USA. However, in other embodiments, service provider system 120 may be maintained by or include another type of service provider.

Service provider system 120 of FIG. 1 includes a data management service 130, service applications 122, a database 126, and a network interface component 128. Data management service 130, service applications 122, and other applications on service provider system 120 may correspond to executable processes, procedures, and/or applications with associated hardware. In other embodiments, service provider system 120 may include additional or different modules having specialized hardware and/or software as required.

Data management service 130 may correspond to one or more processes and/or modules associated specialized hardware of service provider system 120 to provide a platform and framework to store, manage, and delete data when received and/or processed by service provider system 120, such as through use and/or engagement with service application 122 by client device 110 and/or other devices. In this regard, data management service 130 may correspond to specialized hardware and/or software used by service provider system 120 to provide a system to detect user interactions with applications, websites, and/or other digital platforms of service provider system 120 through device interactions, network communications, exchanged API calls, and the like. As such, client device 110 may be detected as engaging with service provider system 120, which may include providing user data (e.g., during account establishment, transaction processing, and the like) and/or generating user data (e.g., through behavioral data tracking). In order to protect the user's privacy and enforce data privacy, retention, and deletion protections, data management service 130 may then request consent for data storage and/or may store data in accordance with corresponding policies and data storage requirements and uses.

Further, data management service 130 may enforce data deletion policies, requirements, and processes to delete or destroy data when requested and/or when RRS thresholds or other time and/or usage thresholds or expiration times are met. As used herein, data deletion may correspond to any process in which data is no longer available and/or readable by service provider system 120 and/or other computing systems, applications, and/or end users. As such, data deletion may include data erasure processes by which data, including encryption keys, are deleted, but may also include data removal or destruction processes that may render data unreadable or undecryptable, such as when an encryption key is deleted and encrypted data and/or cipher text (e.g., text or other data encrypted using an algorithm or other cipher data) is no longer decryptable and is therefore unreadable.

Data management service 130 may initially establish an encryption key for users and/or accounts using a key generator 131, which may be associated with a user, account, and/or device identifier or other information that may be used to identify when data is received, generated, and/or requested to be stored for that particular user, account, or device. For example, an account establishment may be requested for an account of a user, such as through service applications 122 to enable the user to engage in electronic transaction processing or other account activities. An encryption key or other unique data key, string, or identifier (e.g., cipher data) may be generated that may be used to encrypt data and generate encrypted data, cipher text, or the like. The encryption keys generated by key generator 131 for each account, or other corresponding identifier, may be generated to be unique to that account and used as the encryption key for data when stored in associated with the account. As such, the encryption key may be specific to encrypting and decryption data for that account and may correspondingly only encrypt/decrypt that account's data and may be the key usable for that encryption/decryption.

Once an encryption key is generated for an account, key generator 131 may interact with a data access platform 132 to store the encryption key. Data access platform 132 may provide a key store 133 for storage of all encryption keys associated with accounts or other identifiers and may act as the owner or maintainer of such keys. In this regard, key store 133 may be created to be compartmentalized, separate, and/or secluded from other applications, APIs, and/or storages so that the encryption keys remain secure, and access/use of the encryption keys remain with data access platform 132 and/or data management service 130. This may be done to prevent the potential of an encryption key being copied, compromised, or otherwise exchanged and held by other systems and/or storages, thereby ensuring that the encryption key resides in one place and deletion of the encryption key may correspondingly destroy all encrypted data that has been encrypted using that key by rendering that encrypted data unreadable.

PII or other personal, financial, or corresponding data may be received by service provider system 120, such as during use of service applications 122 by client device 110 and/or other devices, servers, or computing systems. For example, client device 110 may utilize their corresponding account and provide account data (e.g., PII, financial data, etc.) or engage in activities and interactions with other accounts, applications, websites, users, etc. When the data is received, data management service 130 may be engaged, initiated, and/or called, such as through one or more API calls, and key store 133 may be utilized to retrieve the corresponding encryption key and encrypt the data. The encrypted data may then be stored, such as in cipher text or data requiring decryption to be readable and/or usable, and the encrypted data may be stored in one or more databases and/or data storage components. During the encryption process, data management service 130 and/or data access platform 132 may perform the encryption process without external applications and/or services and without providing, replicating, or sharing the encryption key to another application and/or service. As such, the computing service requesting data encryption and/or storage, such as one of service applications 122, may call the API of data management service 130 and/or data access platform for encryption but may not be provided a corresponding encryption key to prevent key transmission, duplication, and/or storage elsewhere.

Data management service 130 may then enforce data management and deletion of stored encrypted data through the use of the encryption keys stored by and accessible using key store 133. Data storage may be based on laws, rules, policies, or regulations, such as those corresponding to GDPR or CCPA law, which may govern privacy protected data use, sharing, retention, and deletion. In this regard, unencrypted data may be required by one or more of service applications 122. For example, service applications 122 may receive, or may generate during application execution and/or service provision to devices and users, data access requests 124, which request access to particular data. Data access platform 132 may receive data access requests 124 and identify or determine decryption requests 134 in data access requests 124, which request decryption of, and clear or unencrypted data for, encrypted data stored in one or more data tables, databases, and/or other data storage component. An encryption key for a corresponding one of decryption requests 134 may be retrieved from key store 133 and may be used to decrypt the data. This may be done on platform or service for data management service 130 so that the encryption key is not shared or replicated elsewhere, leading to potential misappropriation or copying.

As such, data management service 130 may manage data access requests 124 by processing decryption requests 134 to provide unencrypted clear text or data for data access requests 124. Key store 133 may also be used by a data destruction platform 135 that may be used to enforce data deletion and erasure policies, requirements, and requests. In this regard, encryption keys may be deleted from key store 133 based on data removal request 114 from client device 110 or other data destruction requests that may be received from devices or applications and/or triggered automatically in response to an RRS threshold or the like. Data destruction processes 136 may be used to destroy, thereby deleting or erasing, data by deleting or erasing an encryption key for the encrypted form of the data. This renders the encrypted form of the data un-decryptable, and therefore unreadable or unusable. As such, destruction processes 136 may manage received and/or automatically triggered requests for data deletion and/or erasure by destroying the data through encryption key deletion from key store 133.

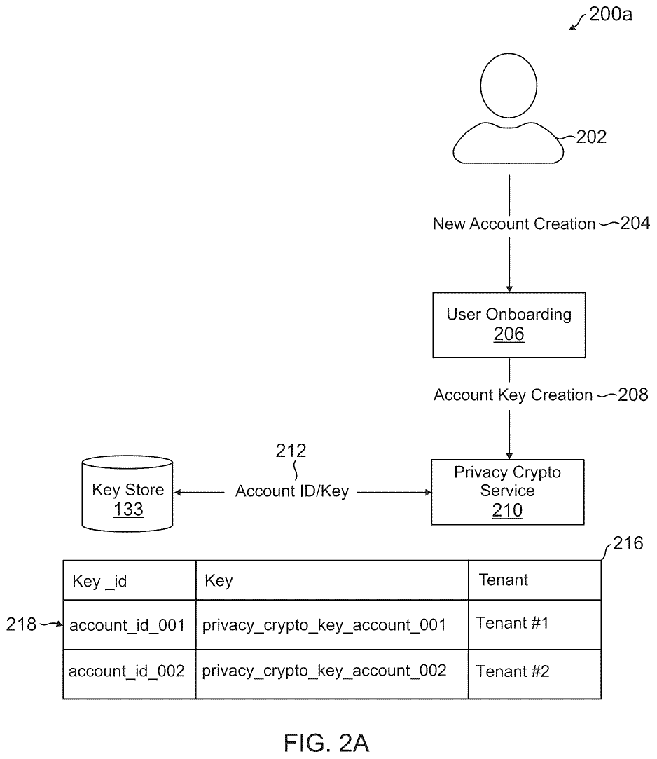

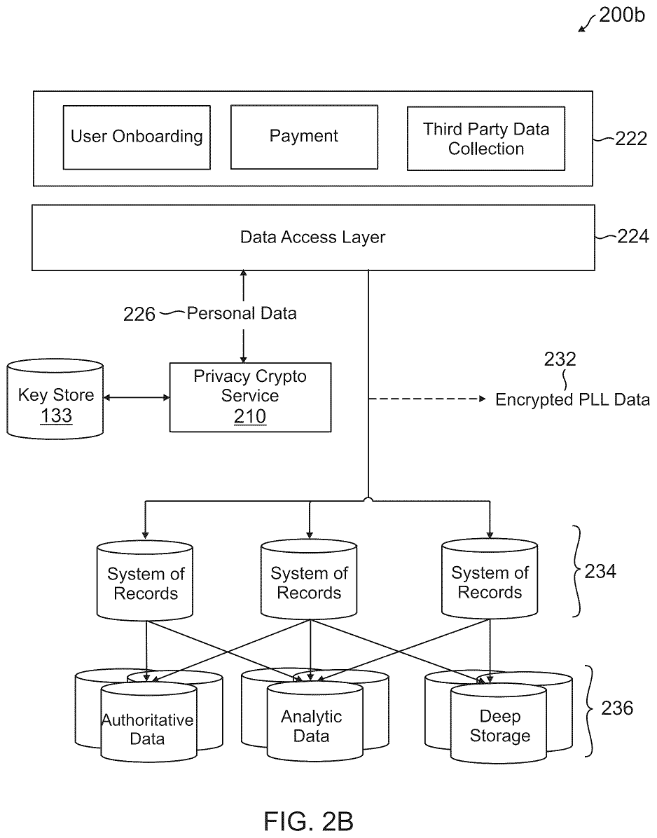

During destruction processes 136, a key deletion 137 may be performed, during which an encryption key associated with data removal request 114 or other data deletion, erasure, and/or destruction request is determined. The encryption key may be identified through a key lookup in key store 133 based on an account identifier or other identification data enabling key lookup and retrieval. Key deletion 137 may the execute a process to delete, erase, or otherwise remove the encryption key from storage and availability so that the key either no longer exists or is removed from all availability. Key deletion 137 may provide proofs of destruction 138 by providing data indicating key deletion 137 has been performed for that encryption key, such as a record of key deletion or erasure. Further for proofs of destruction 138, pseudonymized text for the encrypted form of the data may be determined, generated, and/or provided, which indicates that the data has been rendered unreadable. In this regard, the pseudonymized text in proofs of destruction 138 may include placeholder values and the like in place of the PII data or other encrypted data that is no longer readable and/or decryptable after key deletion 137. Data management and destruction through encryption key deletion is discussed further herein with respect to FIGS. 2A-4 below.

Service applications 122 may correspond to one or more processes to execute modules and associated specialized hardware of service provider system 120 to process a transaction and/or provide other computing services to users. For example, service applications 122 may be used to process payments and other services to one or more users, merchants, and/or other entities for transactions. Service applications 122 may receive and/or generate data, such as account data from PII, financial data, interactions, etc., which may be encrypted and stored using data management services 130, which data access requests 124 being required to access unencrypted forms of that data. In this regard, service applications 122 may correspond to specialized hardware and/or software used by a user to establish a payment account and/or digital wallet, which may be used to generate and provide user data for the user, as well as process transactions. In various embodiments, financial information may be stored to the account, such as account/card numbers and information. A digital token for the account/wallet may be used to send and process payments, for example, through an interface provided by service provider system 120. The financial information may also be used to establish a payment account and provide payments through the payment account.

The payment account may be accessed and/or used through a browser application and/or dedicated payment application. Service applications 122 may be used to process a transaction, such as using an application/website or at a physical merchant location. In some embodiments, service applications 122 may further be used to provide rewards, incentives, benefits, and/or portions of a cost or price of a transaction based on the transaction being processed for a purchasable item. Service applications 122 may process the payment and may provide a transaction history for transaction authorization, approval, or denial. However, in other situations, service applications 122 may instead provide different computing services, including social networking, microblogging, media sharing, messaging, business and consumer platforms, etc. These computing services may be used by customers and users, and therefore those customers and users may provide and/or generate data, which may be stored in accordance with data management service 130. Service applications 122 may require unencrypted forms of such data, and as such, data access requests 124 may be received and/or generated for processing by data management service 130 through decryption requests 134. Service application 122 may also be used to request data deletion through key deletion 137 and destruction processes 136, which may include received requests from user devices, such as data removal request 114 from client device 110, as well as automatically triggered requests.

Service applications 122 as may provide additional features to service provider system 120. For example, service applications 122 may include security applications for implementing server-side security features, programmatic client applications for interfacing with appropriate application programming interfaces (APIs) over network 150, or other types of applications. Service applications 122 may contain software programs, executable by a processor, including one or more GUIs and the like, configured to provide an interface to the user when accessing service provider system 120, where the user or other users may interact with the GUI to view and communicate information more easily. Service applications 122 may include additional connection and/or communication applications, which may be utilized to communicate information to over network 150.

Additionally, service provider system 120 includes or may access database 126. Database 126 may store various identifiers associated with client device 110 and/or other devices and/or servers that may engage and/or interact with accounts, computing services, and/or onboarding processes 124. Database 126 may also store account data, including payment instruments, financial information, account balances, and authentication credentials, as well as transaction processing histories and data for processed transactions. Database 126 may include multiple distributed databases and/or data storage components, which may be used by different systems and applications of service provider system 120 for storage of data that may be encrypted by data management service 130 when received using individualized encryption keys.

Further, database 126 may include key store 133 as a protected and secured data storage component, although key store 133 may also correspond to a storage component stored elsewhere to maintain security and separation from other applications, storages, and the like. Although database 126 is shown as residing on service provider system 120 as a database, in other embodiments, other types of data storage and components may be used including cloud computing storage nodes, remote data stores and database systems, distributed database systems over network 150 and/or of a computing system associated with service provider system 120, and the like.

Service provider system 120 may include at least one network interface component 128 adapted to communicate with client device 110, regulatory systems 140, and/or other devices, servers, and the like directly and/or over network 150. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Regulatory systems 140, which include devices, servers, and other computing systems of regulatory or governing entities, which may be maintained to provide a set of regulatory (e.g., laws, rules, and regulations) requirements and/or guidance for data handling, storage, maintenance, and/or deletion by different online service providers and data storages. In this regard, regulatory systems 140 may include and provide data that may be used to determine a RRS, RRS thresholds, and/or other requirements for data deletion. As such, regulatory systems 140 may be used to determine when data deletion may be required, such as by deleting encryption keys and destroying encrypted data by making the data unencryptable, as therefore may be used to trigger, automatically and/or on user or system consent and approval, data deletion requests for data management service 130.

Service provider system 120 may interact with regulatory systems 140, periodically, on request, or continuously, to maintain a RRS and/or policies and procedures on data deletion, as well as the thresholds and triggers for data deletion through encryption key deletion. Further, service provider system 120 may provide and/or regulatory systems 140 may request proof of data deletion and/or data destruction and may verify such proofs to ensure service provider system 120 and/or the corresponding service provider entity is in compliance with data storage, deletion, and privacy laws, rules, regulations, and the like. As such, proofs of destruction 138 may be received by regulatory systems 140 for processing, retention, and/or provision to client device 110. Regulatory systems 140 may also verify and provide certification of proofs of destruction 138 and/or the service provider for data deletion in compliance with corresponding requirements.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

FIGS. 2A and 2B are exemplary system environments 200a and 200b for establishing an encryption key for an account and encrypting data in order to provide secure data erasure through key deletion, according to embodiments. System environments 200a and 200b may include components referenced with regard to system 100 of FIG. 1, such as the components of service provider system 120 interacting with client device 110 and regulatory systems 140 over network 150. In this regard, system environments 200a and 200b include components of data management service 130 used for account creation, encryption key establishment for secure data erasure, and data encryption, which may be provided in conjunction with service applications 122 for computing service usage by users and devices.

In system environment 200a, initially a user 202 interacts with various applications, websites, and other digital platforms provided by a service provider, such as service provider system 120. For example, user 202 may access different available computing services and online digital platforms using a computing device, such as client device 110, where the user may interact with such services and platforms for account establishment and usage. In this regard, user 202 may initially onboard with the service provider for account usage using a new account creation 204 where user 202 may establish an account and provide details for account usage (e.g., contact information, PII, financial data, KYC information, authentication or identity verification information, etc.). New account creation 204 may provide a user onboarding 206 where user and/or account data is collected, received, and/or generated for the new account. Data collected for new account creation 204 during user onboarding 206 may be stored for the new account by one or more databases and/or data storage systems or components of and/or accessible to the service provider.

To provide secure erasure of this data, as well as subsequent data associated with the account, an account key creation 208 may be performed, which may correspond to a process by key generator 131 to generate and/or assign an encryption key to the new account and new account's identifier (account ID) so that data for the account may be encrypted using such key and an encryption algorithm or process. The encryption key may be generated using a key generation algorithm and process, or may be previously generated in batches or the like and assigned as new accounts are created. Account key creation 208 may assign the key to the account and may be used as a specific key for the account (which may have one or multiple keys), or a key may be shared by linked and/or shared accounts (e.g., in the case of related accounts for a family, single user that has multiple login names or accounts, etc.). In some embodiments, multiple keys may be generated and/or assigned for different types of data and/or different designations of data to encrypt (e.g., for a set time, activity, interaction, transaction, etc.). However, not all account data may require encryption and/or secure erasure through encryption key usage, and as such, other data may not be required to be encrypted using the key from account key creation 208. The encryption key generated by account key creation 208 may be linked to the account ID for the account so that the account ID may be used for key retrieval during encryption, decryption, and data erasure or destruction.

Account key creation 208 may provide the encryption key linked to the account ID to a privacy crypto service 210, which may act as a privacy and data erasure service to ensure data encryption and erasure. Privacy crypto service 210 may utilize the encryption key to encrypt all or a part of the data from user onboarding 206, which may then be stored by one or more storage components and/or databases, as discussed with regard to system environment 200b below. Further, privacy crypto service 210 may provide and store an account ID/key 212 for a data record having the account ID and encryption key, as well as any additional information (e.g., tenant system that may utilize the encryption key and/or account for data storage). In this regard, key store 133 may store account ID/key 212 to a key storage table 218, which may record all held and stored keys by key store 133 including account ID/key 212. Key store 133 may act as the key storage of encryption keys including account ID/key 212, such as in key storage table 218, so that the keys are not duplicated or replicated elsewhere and are not shared with other systems and components during data decryption or other key usage. As such, account ID/key 212 may be stored by key store 133 and/or in key storage table 218 without replication and/or sharing elsewhere, and deletion of account ID/key 212 from key storage table 218 or other encryption key deletion may result in destruction of any encrypted data using the encryption key as the encrypted data may no longer be decryptable or readable.

In some embodiments, key storage table 218 may be replicated in a cold or offline storage, or other secure location, which may generally be inaccessible and only updated at certain times. This may be done to store keys and data, such as account ID/key 212 from key store 133, in a secure location and allow for backup and/or key retrieval if an issue occurs with key store 133 and/or key storage table 218. For example, key storage table 218 may become corrupted, or key store 133 may suffer a computing attack, error, or other issue that affects availability and the capabilities of key store 133 for key retrieval, erasure, and/or data decryption. As such, if a key is accidentally deleted or becomes unavailable, this secure data storage of key storage table 218 and/or other data from key store 133 may serve as a backup and repository to access encryption keys and decrypt data, or provide other operations discussed herein. Additionally, while account ID/key 212 represents a single key for the corresponding account ID, that account ID may have multiple keys and entries in key storage table 218, for example, to encrypt different types or selections of data. This may allow for partial data deletion, such as by deleting financial information while retaining PII, which may be required by regulations and/or customer requests.

Referring now to system environment 200b, a process for data decryption from storage using encryption keys that allow for secure data erasure is shown in further detail. In system environment 200b, data collection components 222 may include different applications, websites, or other platforms where user and/or account data may be detected, received, and/or generated, and therefore may be collected for storage. Data collection components 222 may include user onboarding, payment, or third-party data collection, although other and different types of data collection may also be linked to and integrated with privacy crypto service 210 for data storage through encryption using encryption keys. The data collected may be designated and/or requested to be stored after encryption using an encryption key in order to allow for data destruction and/or removal through key deletion.

As such, when personal data 226 or other data for a user and/or account is collected by data collection components 222, privacy crypto service 210 may be called via a data access layer 224 to encrypt and store personal data 226. Privacy crypto service 210 may call key store 133 and perform a key lookup using the corresponding account ID or other identifier for the user and/or account, and the corresponding encryption key may be retrieved. Privacy crypto service 210 and/or a corresponding encryption engine and/or service may then encrypt personal data 226 using the encryption key and a corresponding encryption algorithm and/or technique. Encryption of personal data 226 using the key from key store 133 may be done without the key being provided outside of privacy crypto service 210 or to other components in order to prevent key replication and/or distribution, which may compromise key deletion and data destruction. Personal data 226 in encrypted form, such as encrypted PII data 232 that may include encrypted data or cipher text, may then be provided to a system of records (SOR) 234 for storage in storage components 236. Additionally, encrypted PII data 232 may be provided to other storage components and/or platforms, which may store encrypted PII data 232 for records and usage when required.

As such, encrypted PII data 232 and/or other encrypted forms of personal data 226 may be required to be decrypted by different applications, components, or platforms of the service provider utilizing the data management service shown in system environment 200b. In this regard, a request for an unencrypted form of encrypted PII data 232 may be generated by a computing service of the service provider, such as when a user is requesting the data and/or interacting with the computing service. The service may make a call to privacy crypto service 210 for decryption of encrypted PII data 232, which may cause a lookup of the encryption key from key store 133. Privacy crypto service 210 may retrieve the encryption key without sharing or duplicating elsewhere, and as such, privacy crypto service 210 may decrypt encrypted PII data 232 and other encrypted data on-platform and/or at privacy crypto service 210 or a corresponding decryption engine and/or application.

Thus, the encryption key may be retrieved from key store 133 by privacy crypto service 210 and used at the service without sharing or transmitting elsewhere. Privacy crypto service 210 may also retrieve the data for decryption. In some embodiments, SOR 234 may be used to perform lookup and retrieval of encrypted PII data 232 from storage components 236, or encrypted PII data 232 may be stored elsewhere and encrypted PII data 232 may be retrieved when the request for decryption is received by privacy crypto service 210, or received with the request. Privacy crypto service 210 may then decrypt the data and may provide the decrypted data to the corresponding requestor computing service or endpoint for processing and/or use. The encryption key from key store 133 may not be shared for this process and the decrypted data may be marked for deletion after processing and/or use so that personal data 226 is not stored in clear text or form elsewhere and may be destroyed from storage by deleting the corresponding encryption key.

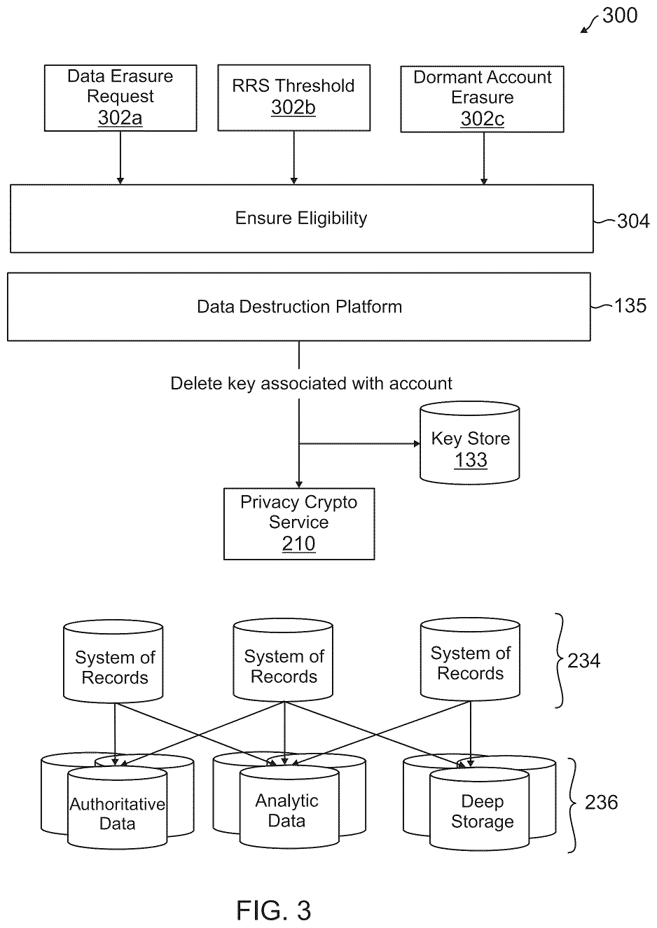

FIG. 3 is an exemplary system environment 300 for key deletion to ensure secure data erasure by rendering encrypted data unreadable and unable to be decrypted, according to an embodiment. System environment 300 may include components referenced with regard to system 100 of FIG. 1, such as the components of service provider system 120 interacting with client device 110 and regulatory systems 140 over network 150. In this regard, system environment 300 includes components of data management service 130 used for data destruction through key deletion, erasure, and/or removal so that encrypted data can no longer be decrypted and/or available in readable form, which may be provided in conjunction with service applications 122 for managing data deletion and/or removal requests and RRS thresholds.

In system environment 300, data deletion, erasure, removal, and/or destruction requests may be received from a variety of sources and endpoints, such as those that may be associated with user requested data deletions and/or destructions, as well as those that may be automatically triggered based on certain conditions, thresholds, or requirements. In this regard, data destruction requests 302a-c may correspond to these requests generated by different circumstances including user or automatically generated requests. For example, a data erasure request 302a may correspond to a request for data erasure generated by client device 110 interacting with service provider system 120 to request data destruction through key deletion 137, although the mechanism of data erasure and destruction may be unknown to the user of client device 110. As such, data destruction request 114 may correspond to and/or trigger data erasure request 302a in system environment 300. Erasure eligibility 304 may determine whether data erasure request 302 is legitimate, authorized, and/or verified, such as by authenticating a user and/or device. This may include verifying and/or authenticating account credentials and/or account permissions for data erasure and key deletion 137 to be performed for a corresponding encryption key.

However, other types of data erasure and/or deletion requests may be received and/or triggered for other conditions. For example, RRS threshold erasure 302b may be triggered based on an RRS schedule, threshold, and/or expiration date, time, or threshold for data retention, as established for compliance requirements and/or with SOR 234. As such, RRS threshold erasure 302b may be triggered automatically and not by a user request. Similarly, a dormant account erasure 302c may be triggered by a threshold for account activity, such as a number of days, months, or years since a last use, login, or the like. Dormant account erasure 302c may be triggered by a threshold set for data compliance and retention schedules and requirements, such as an RRS established for data compliance and inactivity or expired data deletion or may be triggered based on set schedules for data erasure and cleaning for storage optimization. As such, erasure eligibility 304 may be run on RRS threshold erasure 302b and/or dormant account erasure 302c, which may ensure that the proper authentication, verification, and/or trigger condition has been met and/or provided from the endpoint triggering such requests, which may include verifying API calls and/or digital signatures with calls and/or ensure the condition meets the eligibility criteria or requirements and was not improperly triggered.

Data destruction platform 135 may then handle data destruction by deleting, erasing, or removing the corresponding encryption key for the request, account ID with the request, or other identifier used to signify the data for destruction via key deletion. Data destruction platform 135 may interact with key store 133 to have the encryption key identified and removed, such as through erasure and/or deletion from memory and storage by key store 133. As such, an API call by privacy crypto service 210 to key store 133 may request the encryption key be deleted, such as a delete operation for a data table or other data storage having the encryption key. Key store 133 may then be updated to have the encryption key deleted and/or removed, which may cause the encrypted data stored by storage components 236 to no longer be decryptable and readable or processable in clear text or data form. As such, when SOR 234 is used to retrieve the encrypted data, it may no longer be decryptable and instead pseudonymized text may be provided in place of the PII data or other sensitive data that may have been encrypted by the now deleted encryption key.

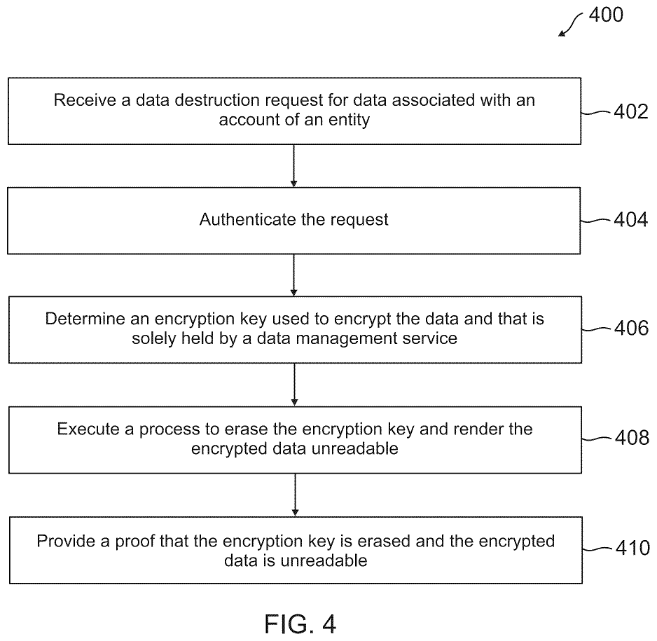

FIG. 4 is a flowchart 400 for a secure data erasure framework using individualized encryption key management, according to an embodiment. Note that one or more steps, processes, and methods described herein of flowchart 400 may be omitted, performed in a different sequence, or combined as desired or appropriate.

Initially, at a step 402 of flowchart 400, a data destruction request for data associated with an account of an entity is received. Computing device 110 may interact with service provider system 120 via an application, website, or other channel and/or online digital platform. Service provider system 120 may receive user data and/or track user data from the interactions, which may require a consent to store and/or maintain storage. This consent may be automatically opted-in and/or provided based on use, however, revocation of the consent may occur later, and the user may request that data is deleted by service provider system 120. Further, regulatory system 140 may impose limits on data storage, such as a length of time data may be stored, after which, the data may be required to be deleted. As such, to comply with data storage policies, requirements, and requests, service provider system 120 may receive a data removal request 114 from client device 110 or another data destruction request, such as one triggered by an RRS threshold or the like for service provider system 120. Since different types of data may have different data storage and erasure requirements, RRS thresholds may be triggered for different types of data and different corresponding encryption keys that encrypt that data. As such, the request may be specific to a type of data and/or encryption key that encrypts that type of data for the user and/or one or more other users (e.g., in the event of a system-wide data cleaning and erasure event that occurs periodically, such as monthly). The request may include an account identifier or other identification information allowing for identification of the account.

At step 404, the request is authenticated. For requests from external devices and/or users, the request may be required to be authenticated by providing sufficient account and/or authentication information, verifying an identity, or the like. In this regard, client device 110 may provide authentication information when providing data removal request 114 or may otherwise authenticate their identity and/or for account usage. As such, data destruction platform 135 may authenticate external devices and/or users so that data removal requests may be verified and authenticated prior to data removal, erasure, and/or destruction. However, data destruction requests may also be received from internal system components and/or triggering mechanisms, such as RRS thresholds and/or compliance requirements and systems. As such, the internal systems may be verified and authenticated through trusted integrations, secure channels, and the like. API calls exchanged between internal components and data destruction platform 135 may include digital signatures or trust mechanisms to authenticate data destruction requests.

At step 406, an encryption key used to encrypt the data and that is held by a data management service is determined. Key store 133 may store different encryption keys associated with accounts, where key store 133 acts as the key storage repository and location of encryption key storage so that the keys are not replicated and/or stored elsewhere and a single processing job or thread to delete one or more encryption keys with key store 133 may entirely delete and erase the key, removing the key from availability and/or destroying the key and likewise destroying any data encrypted using the keys. As such, key deletion 137 from key store 133 may cause encrypted data to become unreadable and un-decryptable. A key may be identified and/or determined from key store 133 based on the corresponding account identifier for the account for which data destruction is requests. The key may therefore be stored in association with such account identifier, where the account identifier may be used for past data encryptions and storage of encrypted data for the account when received or generated. The account may also have multiple keys associated with corresponding types of encrypted data, each of which may have different data storage and/or erasure requirements and/or may be separately encrypted to allow of more specific data erasure of certain types of data (e.g., erasure of financial data while retaining PII data or other personal information, erasure of payment instrument data for a specific payment instrument while retaining other financial data, etc.). As such, the key may be identified for the account, as well as more granularly for the type and/or specification of the data to be deleted and/or destroyed.

At step 408, a process to erase the encryption key and render the encrypted data unreadable is executed. Data destruction platform 135 includes destruction processes 136 that may be used to destroy data by erasing, deleting, or removing encryption keys from key store 133. In this regard, after receiving and authenticating the data destruction request, service provider system 120 may utilize data destruction platform 135 to handle destruction of the encryption key identified from key store 133 at step 406. As such, at step 408, key deletion 137 of destruction processes 136 may be executed to delete the encryption key, such as by erasing or removing from storage. As key store 133 acts as the single storage, owner, and maintainer of the encryption key, when performing key deletion 137 of the encryption key, the key may no longer exist and be capable of decrypting data that has been encrypted using the key and is stored in encrypted form. As such, the data in encrypted form may be considered to be destroyed by being unavailable for decryption and now unreadable after key deletion 137.

At step 410, a proof that the encryption key is erased, and the encrypted data is unreadable, is provided. Once key deletion 137 has been performed, proofs of destruction 138 may document and/or record processes and/or records of key deletions, including records of key erasure, storage and/or table updates that include removal or deletion of key records, and the like. Further, proofs of destruction 138 may include one or more records of the encrypted data showing that the encrypted data is no longer readable and/or decryptable, as well as pseudonymized text or data that may be used in place of the underlying data and/or encrypted data that is unavailable and/or unreadable. Proofs of destruction 138 may be provided to client device 110 in response to data removal request 114, as well as regulatory systems 140 for proof of data privacy and deletion compliance.

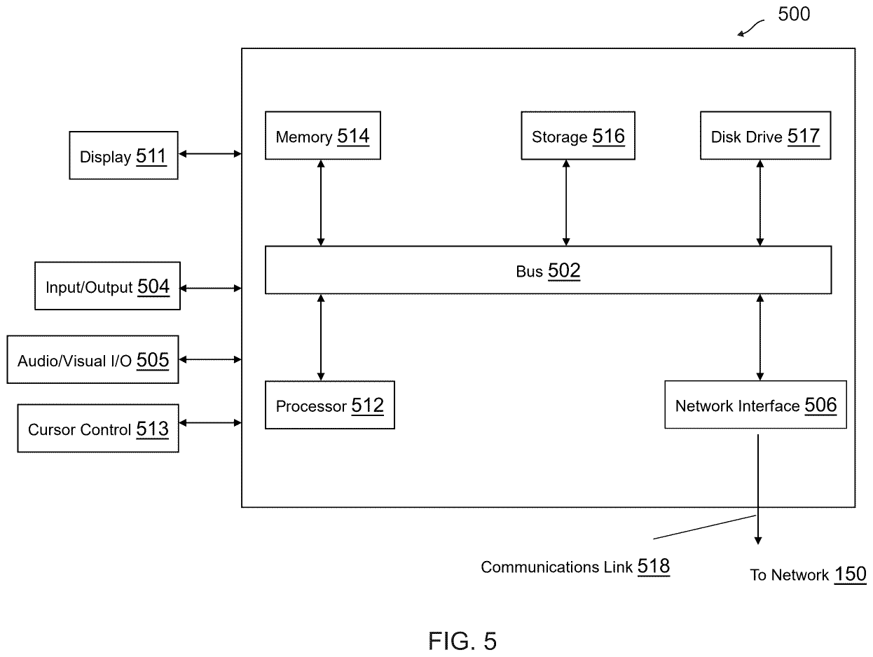

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to execute instructions to cause the system to:
receive a request to remove data associated with an account of a service provider, wherein the request includes at least an account identifier (ID) for the account, and wherein the data is stored in an encrypted form using an encryption key associated with the account;
authenticate the request;
determine the encryption key used for the encrypted form of the data, wherein the encryption key is required to decrypt the encrypted form of the data, and wherein the encryption key is stored by a data management service associated with a data removal platform handling the request without replication outside of the data management service; and
execute a process to erase the encryption key from the data removal platform, wherein the process renders the encrypted form of the data unreadable after the encryption key is erased.

2. The system of claim 1, wherein, prior to receiving the request, executing the instructions further causes the system to:
receive a request for a generation of the encryption key for the account at the data management service, wherein the request for the generation is based on at least one of an account enrollment of the account or a data collection of the data including at least one of personally identifiable information (PII) data or sensitive data; and
generate and store the encryption key at the data management service.

3. The system of claim 2, wherein the at least one of the PII data or the sensitive data is encrypted using the encryption key, and wherein the account ID is linked to the encryption key across a plurality of computing services that utilize the at least one of the PII data or the sensitive data.

4. The system of claim 2, wherein executing the instructions further causes the system to:
receive the at least one of the PII data or the sensitive data during an activity performed using the account; and
encrypt, at the data management service, the at least one of the PII data or the sensitive data using the encryption key without sharing the encryption key outside of the data management service.

5. The system of claim 1, wherein the encrypted form of the data is encrypted using the encryption key based on at least one of a data security requirement, a privacy data retention regulation, or a data erasure policy, and wherein the data erasure policy causes the process to be executed in compliance with the data security requirement and the privacy data retention regulation.

6. The system of claim 1, wherein executing the process comprises:
deleting the encryption key from a storage accessible by the data management service; and
providing a pseudonymized text for the data identifying that the data has been rendered unreadable, wherein the pseudonymized text includes placeholder values in place of PII data.

7. The system of claim 6, wherein executing the instructions further causes the system to:
provide a proof of the data being rendered unreadable based on the deleting the encryption key, wherein the proof is provided for at least one of a data retention record or a regulatory compliance.

8. The system of claim 1, wherein, prior to receiving the request, executing the instructions further causes the system to:
receive a request to access the data from the encrypted form of the data;
authorize the request to access the data;
decrypt, at the data management service, the encrypted form of the data using the encryption key; and
provide the data in an unencrypted form in response to the request.

9. The system of claim 8, wherein decrypting the data is performed without sharing the encryption key outside of the data management service including without providing the encryption key to a requestor of the request to access the data, and wherein the request is received from a computing service corresponding to the requestor using an integration between the computing service and the data management service that authorized the computing service for access to the unencrypted form of the data.

10. A method comprising:
detecting an account establishment of an account for an entity with a service provider, wherein the account establishment creates an account identifier (ID) for the account;
generating an encryption key usable to encrypt data associated with the account;
storing the encryption key with a data management service associated with a data removal platform, wherein the encryption key is stored with the data management service and the encryption key is not replicated outside of the data management service, and wherein the data removal platform manages removal of the data using the encryption key;
encrypting the data using the data management service and the encryption key;
receiving a data removal request of the data;
determining the encryption key with the data management service; and
erasing, by the data removal platform, the encryption key from key management service, wherein the erasing causes the encrypted data to become unreadable.

11. The method of claim 10, wherein the data comprises at least one of personally identifiable information (PII) data, financial data, or sensitive data, and wherein the data is received or generated prior to the encrypting based on a use of a service application associated with the service provider.

12. The method of claim 10, wherein the encrypted data is stored by a plurality of databases of the service provider, and wherein the data management service manages decryptions of the encrypted data from the plurality of databases.

13. The method of claim 10, further comprising:
providing a pseudonymized text for the data identifying that the data has been rendered unreadable based on the erasing the encryption key.

14. The method of claim 10, further comprising:
providing a proof of the data being rendered unreadable based on the erasing the encryption key.

15. The method of claim 10, wherein, prior to the receiving the data removal request, the method further comprises:
receiving a request for the data based on the encrypted data stored by a database of the service provider; and
decrypting the encrypted data using the encryption key and the data management service.

16. The method of claim 10, wherein the decrypting is performed by the data management service using a key store inaccessible to other applications and other systems associated with the service provider.

17. A non-transitory machine-readable medium having stored thereon machine-readable instructions executable to cause a machine to perform operations comprising:
determining data associated with an account that is stored by at least one database of a service provider is to be deleted, wherein the data was encrypted prior to storing by the at least one database using an encryption key associated with the account, and wherein the encryption key is required to decrypt the data to decrypted data;
determining an account identifier (ID) for the account;
identifying the encryption key used for the encrypted form of the data using the account ID from a key store, wherein the encryption key is stored by the key store associated with a data management service and not shared by the data management service for decrypting the data from the at least one database to the decrypted data;
executing a key deletion process that deletes the encryption key from the key store;
rendering the data unreadable based on executing the key deletion process; and
generating pseudonymized text for the data that replaces at least a portion of the decrypted data that is unavailable after executing the key deletion process.

18. The non-transitory machine-readable medium of claim 17, wherein the determining that the data is to be deleted comprises receiving a request for a data destruction associated with the account from a client device, wherein the request includes the account ID.

19. The non-transitory machine-readable medium of claim 17, wherein the determining that the data is to be deleted comprises detecting a trigger of a data destruction associated with the account based on a threshold for the data destruction.

20. The non-transitory machine-readable medium of claim 19, wherein the threshold is based on a record retention schedule (RRS) for the service provider, and wherein the RRS is associated with a policy for data retention by the service provider.
